(19) United States
(12) Patent Application Publication
(10) Pub. No.: US 2026/0325976 A1
(43) Pub. Date: Oct. 22, 2026

(54) SYSTEM AND METHOD FOR REAL-TIME VISUAL ANALYSIS AND PREDICTIVE SIMULATION IN VIDEO GAMES

(71) Applicant: Todd Stephen Hays, Timonium, MD (US)

(72) Inventor: Todd Stephen Hays, Timonium, MD (US)

(21) Appl. No.: 19/466,404

(22) Filed: Jan. 31, 2026

Related U.S. Application Data
(60) Provisional application No. 63/751,845, filed on Jan. 31, 2025.

(51) Int. Cl. A63F 13/85; A63F 13/497; A63F 13/573

(52) U.S. Cl. CPC A63F 13/85; A63F 13/497; A63F 13/573

(57) ABSTRACT

A system and method for real-time video game coaching that processes a live visual feed from a video game to construct and maintain a predictive digital simulation of game-state and physics, enabling the generation of frame-specific, pixel-precise instructional feedback that optimizes user performance beyond the capabilities of language model-based assistants. The system comprises a computing device, a network, a database, a server, and user devices. The system that evaluates live combat state variables, predicts incoming attacks based on observed patterns, and advises optimal action timing and resource management within dynamic combat systems. The system that generates dynamic spatial maps, including probability and visibility maps, from visual input to assess tactical conditions such as line-of-sight and patrol patterns, and delivers real-time tactical intelligence.

### FIELD OF THE INVENTION

The present disclosure relates generally to computer-implemented systems for interactive digital entertainment, and more particularly to a system and method for real-time video game coaching that processes a live visual feed from a video game to construct and maintain a predictive digital simulation of game-state and physics, enabling the generation of frame-specific, pixel-precise instructional feedback that optimizes user performance beyond the capabilities of language model-based assistants.

### BACKGROUND

The field of automated video game assistance encompasses several technological approaches, each with inherent limitations that prevent genuine real-time, frame-accurate coaching. The most prevalent approach leverages Large Language Models (LLMs) trained on massive corpora of game-related text, including wikis, forums, and official guides. These systems function by predicting statistically relevant text sequences in response to player queries. However, their operation is entirely divorced from the live gameplay environment. They possess no sensory input modality for processing the visual game state, rendering them incapable of perceiving critical real-time parameters such as sprite coordinates, velocity vectors, enemy animation cycles, or environmental interactables. Consequently, while able to recite that “a jump is required to cross a pit” in a platformer, an LLM-based assistant cannot calculate the pixel-perfect distance to the pit's ledge, determine the required jump velocity given the game's gravity constant, or issue the command “Jump!” at the exact frame necessary for success.

A second class of prior art involves static, scripted guides integrated into game clients or overlay applications. These systems operate by matching predefined game-state flags or player location data against a database of pre-authored hints and visual markers. However, this methodology is fundamentally reactive and brittle. The guidance is triggered by simple conditional checks (For example, “if player in Zone X, display hint Y”) without capacity for reasoning about the dynamic game state. It cannot adapt to player error, unpredictable enemy behavior, or emergent gameplay situations. For instance, such a guide could indicate the location of a puzzle block in an adventure game, but it cannot analyze the room in real time to determine if the block is currently moveable, if an enemy is guarding it, or which specific sequence of pushes is required, given the player's immediate surroundings.

Research into game-playing artificial intelligence, particularly via reinforcement learning (RL), constitutes a third area of prior art. RL agents learn optimal policies by interacting with a game's environment, often developing sophisticated strategies. However, the internal representations or “models” learned by these agents are optimized for direct action selection, not for generating explicable, human-consumable coaching. The decision-making process is typically a black box, and the agent's policy is not decomposable into sequential, verbal instructions like “dodge left now, then fire.” Furthermore, these systems are designed to replace the player, not to collaborate with them, and lack an architecture for converting their internal state assessments into real-time, pedagogical output synchronized to a human's perceptual latency and skill level.

Computer vision (CV) techniques applied to gameplay video for purposes such as automated moderation, speedrun verification, or highlight detection represent a fourth technological category. These methods analyze pixel data to identify objects, detect glitches, or classify events. However, their application is overwhelmingly post-hoc and diagnostic. A CV system might confirm that a player achieved a specific goal by detecting a certain pixel pattern at a timestamp, but it does not maintain a running, predictive simulation of the game world. It lacks a model of game physics to forecast future states (For example, predicting the trajectory of a projectile or the patrol path of an enemy) and contains no module for synthesizing proactive advice. Its function is observational, not simulative or instructive.

Prior art reference US 2018/0253452 A1 describes a system for providing contextual help by correlating a player's current in-game statistics (For example, health, ammunition, map progress) with a curated knowledge base. However, this system depends entirely on the game exposing these statistics via a direct application programming interface (API). It is blind to elements of game state not explicitly provided by the API, such as the precise on-screen position of a non-player character, the timing of a moving platform's cycle, or the visual tell preceding a boss's attack. It cannot function with games that lack such an API, which includes all legacy console titles, thereby failing to provide a universal solution based on visual analysis.

Another prior art reference, JP 2020-125678 A, discloses a coaching system that uses replay data from expert players. It analyzes temporal sequences of expert actions (For example, button presses) and game-state snapshots to suggest macro-level strategy improvements. However, this analysis operates on abstracted event logs and not on raw visual input. It can suggest “use ability X more frequently,” but it cannot generate the micro-level, frame-critical guidance required to execute a complex maneuver, such as the precise jump-and-aim timing needed to bypass a sequence of moving hazards. Its granularity is that of entire matches or minutes, not individual frames.

Consequently, existing technologies are architecturally distinct from and incapable of delivering the core functionality of real-time, predictive coaching derived from visual perception. LLM-based tools lack perceptual grounding, static guides lack adaptability, game-playing AIs lack explicability and a coaching-oriented design, and diagnostic CV systems lack predictive simulation. All prior approaches fail to integrate real-time pixel processing with a dynamic world model that simulates game physics and entity behaviors to anticipate future states and calculate optimal, frame-specific interventions. This gap highlights the necessity for a system built upon a perceptual world-model architecture.

Therefore, there is a need for a system and method for real-time video game coaching that processes a live visual feed from a video game to construct and maintain a predictive digital simulation of game-state and physics, enabling the generation of frame-specific, pixel-precise instructional feedback that optimizes user performance beyond the capabilities of language model-based assistants. There is also a need for a system that analyzes raw pixel data to measure in-game spatial relationships in units of pixels and frames, computes physics-based trajectories including jump arcs and projectile paths, and predicts entity movement patterns to provide temporally precise action commands. There is also a need for a system that reconstructs a navigable model of a game environment from visual output, identifies interactable objects and their states within that model, and generates context-specific guidance for puzzle solving and navigation.

There is also a need for a system that generates dynamic spatial maps, including probability and visibility maps, from visual input to assess tactical conditions such as line-of-sight and patrol patterns, and delivers real-time tactical intelligence. There is also a need for a system that understands and calculates momentum, velocity, and environmental physics such as friction and ramp mechanics to determine optimal pathways and anticipate hazard timing for performance optimization. There is also a need for a system that interprets real-time enemy attack cycles and patterns, predicts precise frame timing for defensive and offensive actions, and provides adaptive, moment-to-moment combat coaching. There is also a need for a system that evaluates live combat state variables, predicts incoming attacks based on observed patterns, and advises optimal action timing and resource management within dynamic combat systems.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a system and method for real-time video game coaching that processes a live visual feed from a video game to construct and maintain a predictive digital simulation of game-state and physics, enabling the generation of frame-specific, pixel-precise instructional feedback that optimizes user performance beyond the capabilities of language model-based assistants. In one embodiment herein, the system comprises a computing device, a network, a database, a server, and a user device.

In one embodiment herein, the computing device having at least one processor and a memory storing instructions that, when executed by the processor, cause the processor to implement a plurality of modules. The computing device is in communication with the server and the database via the network. The computing device is implemented as a server-side analysis engine and the user device is configured to stream the live video feed to the computing device via the network.

In one embodiment herein, the plurality of modules comprises a video processing module, an object detection and tracking module, a simulation module, a state prediction module, an action recommendation module, and an output module. In one embodiment herein, the video processing module is configured to receive a live video feed of a video game from the user device and to convert sequential video frames into a normalized numerical tensor representation.

In one embodiment herein, the object detection and tracking module is configured to process the normalized numerical tensor representation using at least one trained convolutional neural network and related computer-vision algorithms to identify, classify, and continuously track a plurality of game entities and environmental elements within the video frames, including determining pixel-based coordinate data and velocity vectors.

In one embodiment herein, the object detection and tracking module is configured to detect at least one of player-controlled characters, non-player characters, projectiles, collectibles, environmental hazards, or interactable objects within the video frames. The object detection and tracking module measures distances between entities in pixel units, infers motion vectors by tracking entity positions across successive frames, and calculates time-to-collision values in video frame units based on measured distances and relative velocities. The object detection and tracking module is further configured to identify interactable environmental objects by comparing detected textures against a database of interactive object patterns.

In one embodiment herein, the simulation module is configured to implement a physics engine that operates on the pixel-based coordinate data and velocity vectors output from the object detection and tracking module to compute predicted motion outcomes using game-specific physical constants. The game-specific physical constants are retrieved from the database or inferred from observed gameplay behavior. The predicted motion outcomes include at least one of jump trajectories, projectile paths, collision outcomes, momentum conservation, friction effects, or ramp traversal mechanics.

In one embodiment herein, the state prediction module is configured to analyze historical tracking data, simulation outputs generated by the simulation module, and game-specific behavior models retrieved from the database to forecast future game states. The state prediction module is configured to predict future state transitions of one or more detected entities by analyzing temporal visual patterns, motion vectors, animation states, or historical trajectory data derived from sequential video frames.

In one embodiment herein, the state prediction module is configured to generate at least one of a line-of-sight probability map or a visibility heatmap based on reconstructed spatial geometry of the game environment. The state prediction module is configured to forecast environmental state changes including moving platforms, timed hazards, or dynamic obstacles.

In one embodiment herein, the action recommendation module is configured to generate real-time coaching instructions by applying rule-based decision logic, utility functions, and policy models to a current game state and at least one forecasted future game state generated by the state prediction module. The action recommendation module is configured to select coaching instructions from movement actions, attack actions, defensive actions, or interaction actions based on predicted risk and reward.

In one embodiment herein, the coaching instructions include pixel-precise spatial directives and temporally-bound action commands mapped to specific future video frames. The action commands are generated with an execution timing tolerance of ±3 video frames relative to a predicted optimal execution frame.

In one embodiment herein, the output module is configured to format the coaching instructions generated by the action recommendation module into a modality-appropriate representation and to deliver the formatted coaching instructions to the user device in temporal alignment with the live video feed. The output module is configured to render visual overlays on the live video feed that depict at least one of recommended movement paths, predicted entity positions, or action timing indicators. The output module is configured to deliver the coaching instructions as synthesized audio prompts or haptic feedback synchronized to predicted gameplay events.

According to an aspect, a method is disclosed for real-time video game analysis and coaching using the system. First, at one step, the video processing module receives the live video feed of the video game from the user device and converts sequential video frames of the live video feed into a normalized numerical tensor representation. At another step, the object detection and tracking module processes the normalized numerical tensor representation using at least one trained convolutional neural network and related computer-vision algorithms to identify, classify, and continuously track a plurality of game entities and environmental elements within the video frames, including determining pixel-based coordinate data and velocity vectors.

At another step, the simulation module simulates in-game physics by operating the physics engine on the pixel-based coordinate data and velocity vectors to compute predicted motion outcomes using game-specific physical constants. At another step, the state prediction module forecasts future game states by analyzing historical tracking data, simulation outputs generated by the simulation module, and game-specific behavior models retrieved from the database.

At another step, the action recommendation module generates real-time coaching instructions by applying rule-based decision logic, utility functions, and policy models to the current game state and at least one forecasted future game state generated by the state prediction module. Further, at another step, the output module delivers the coaching instructions to the user device in temporal alignment with the live video feed.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a system for real-time video game analysis and coaching, in accordance with embodiments of the invention.

FIG. 2 illustrates a bloc diagram of a compositor architecture of the system, in accordance with embodiments of the invention.

FIG. 3 illustrates a flow chart of a method for real-time video game analysis and coaching using the system, in accordance with embodiments of the invention.

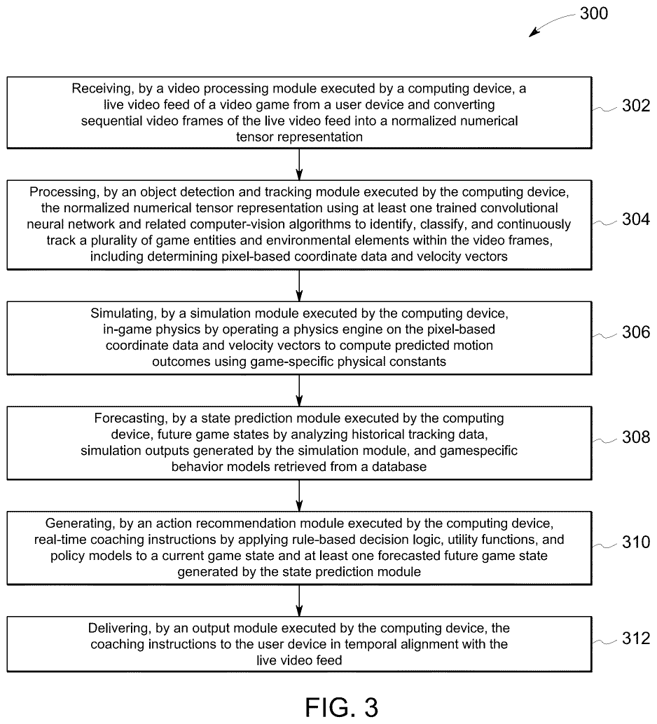

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

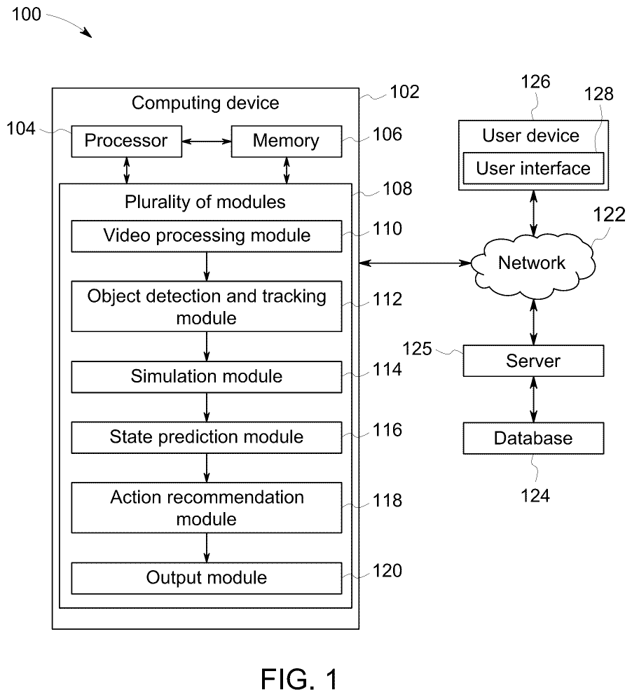

FIG. 1 refers to a block diagram of a system 100 for real-time video game analysis and coaching. In one embodiment herein, the system 100 is configured to ingest a live video feed of a video game, reconstruct a structured representation of the game world at a pixel and frame level, simulate future game states using a physics-based world model, and deliver frame-synchronized coaching instructions to a user in real time. As used herein, the world model comprises a structured, machine-readable representation of detected entities, spatial relationships, motion vectors, and temporal state transitions derived from sequential video frames and continuously updated as new frames are processed.

The disclosed system 100 improves computer-based video analysis by enabling real-time interpretation of dynamic, interactive visual environments that cannot be reliably analyzed by human observers or generic video processing techniques. The system 100 performs frame-level object detection, spatial-temporal state modeling, and forward simulation under real-time latency constraints to generate synchronized visual outputs during live gameplay.

In one embodiment herein, the disclosed system 100 is applicable to a plurality of video game types and interactive digital environments, including but not limited to action games, sports games, strategy games, role-playing games, simulation games, multiplayer online games, turn-based games, and hybrid game formats. The system 100 operates independently of specific game rules, engines, or genre constraints and derives actionable insights based on visual state transitions observable within the video feed. Although described primarily with reference to video games, the disclosed system 100 is equally applicable to other interactive visual environments, including but not limited to virtual simulations, training environments, serious games, educational simulations, digital twins, and mixed-reality or augmented-reality environments, where real-time visual analysis and predictive guidance are beneficial.

In one embodiment herein, the system 100 comprises a computing device 102, a network 122, a database 124, a server 125, and a user device 126. In one embodiment herein, the system 100 is deployed using a distributed architecture in which one or more components execute locally on the user device 126, remotely on cloud-based infrastructure, or in a hybrid configuration. Video processing, prediction, and output generation may be partitioned across multiple computing nodes to satisfy latency, scalability, or performance requirements.

In one embodiment herein, the computing device 102 comprises at least one processor 104 and a memory 106. The memory 106 is a non-transitory computer-readable medium storing program instructions that, when executed by the processor 104, cause the processor 104 to implement a plurality of modules 108. In one embodiment herein, the plurality of modules 108 comprises a video processing module 110, an object detection and tracking module 112, a simulation module 114, a state prediction module 116, an action recommendation module 118, an output module 120.

In one embodiment herein, the term “processor” refers to a hardware processing unit including, but not limited to, a Central Processing Unit (CPU), Graphics Processing Unit (GPU), Physics Processing Unit (PPU), Digital Signal Processor (DSP), Field Programmable Gate Array (FPGA), Application-Specific Integrated Circuit (ASIC), Application-Specific Instruction-Set Processor (ASIP), microprocessor, microcontroller, or any combination thereof. In some embodiments, the processor 104 comprises a plurality of processing cores configured to execute instructions independently or in parallel to enable real-time video processing, simulation, and prediction tasks.

In one embodiment herein, the memory 106 comprises one or more non-transitory computer-readable storage media including, but not limited to, random access memory (RAM), static RAM (SRAM), read-only memory (ROM), electrically erasable programmable read-only memory (EEPROM), flash memory, hard disk storage, magnetic storage, optical storage, solid-state drives, or any combination thereof. The memory 106 stores executable instructions, trained machine learning models, neural network parameters, game-specific physical constants, behavior templates, and historical game state data used by the system.

In one embodiment herein, the network 122 includes one or more wired or wireless communication networks. Examples of wired networks include, but are not limited to, Local Area Networks (LAN), Wide Area Networks (WAN), Ethernet networks, and intranets. Examples of wireless networks include, but are not limited to, cellular networks, Wi-Fi, Wi-Fi Direct, Bluetooth, Bluetooth Low Energy, Zigbee, Ultra-Wideband (UWB), Near Field Communication (NFC), infrared communication, and combinations thereof.

In one embodiment herein, the user device 126 represents an electronic device that a user can utilize to interact with the system 100 and to play or view a video game being analyzed. In one embodiment herein, the user device comprises a terminal device capable of wireless or wired communication, including but not limited to smartphones, tablets, desktop computers, laptops, gaming consoles, wearable devices, head-mounted displays, or other computing devices capable of rendering video and receiving coaching instructions. The user device 126 serves as the user's gateway to accessing and interacting with the system 100. The user device 126 is configured to enable the user to engage with functionalities and capabilities of the system 100 through a user interface 128. In one embodiment herein, the user device 126 is further configured to provide the live video feed of the video game to the system 100 and to present frame-synchronized coaching instructions generated by the system 100, including visual overlays that depict predicted entity positions, optimal movement paths, and action timings in an interpretable manner.

In one embodiment herein, the user interface 128 is a crucial component of the user device 126, which allows the user to receive information and cooperate with the operation of the system 100. The user interface 128 is a display unit configured to render the video game content and to superimpose coaching information generated by the system without introducing perceptible latency to the video game content. 100. The user interface 128 can be, but is not limited to, a monitor, a television screen, a laptop display, or a mobile device screen. The versatility of the user interface 128 ensures that the user can engage with the system 100 in a manner that is visually intuitive and context-aware, thereby catering to a wide range of user preferences and accessibility needs. The user device 126 may further comprise input devices such as a keyboard, a mouse, a game controller, a touchscreen, or other input peripherals that allow the user to execute actions in the video game in response to the coaching instructions displayed on the user interface 128.

In one embodiment herein, the computing device 102 is configured to operate as a centralized analysis engine that receives a live video feed of a video game from the user devices 126, performs world-model based processing on pixel-level data, and generates coaching instructions with frame-level timing precision and pixel-level spatial accuracy. In one embodiment herein, the computing device 102 is configured to communicate with the user device 126 via the network 122 to receive the live video feed of the video game and to transmit real-time coaching instructions back to the user interface 128. The computing device 102 comprises the processor 104 and the memory 106 storing executable instructions that implement a plurality of modules 108 corresponding to video analysis, world-model simulation, and instruction generation. In one embodiment herein, the computing device 102 is further configured to connect to the database 124 via the network 122 to retrieve game-specific physical constants, enemy behavior patterns, and coaching rule sets, and to utilize this information to parameterize processing of the live video feed and to improve the accuracy and relevance of the coaching instructions delivered to the user device 126.

In one embodiment herein, the network 122 acts as a communication channel that allows the computing device 102 to interact with the user device 126 and the database 124, thereby facilitating the exchange of video frames, prediction results, and coaching information. In one embodiment herein, the network 122 can be, but is not limited to, a local area network (LAN), a cellular network, a wide area network (WAN), an intranet, a virtual private network (VPN), and wireless networks that use radio frequency (RF) or infrared (IR) technology to transmit data without the need for physical cables, thereby providing mobility and flexibility. The versatility of the network 122 ensures that the computing device 102 can seamlessly connect to the user device 126 and the database 124, thereby enabling the user to access functionalities and resources of the system 100 from a variety of locations and devices. This connectivity enhances the overall accessibility and convenience of the system 100 for the user.

In one embodiment herein, the processor 104 of the computing device 102 is configured to execute the plurality of modules 108 to perform real-time video game analysis, world-model construction, state forecasting, and coaching-instruction generation within the system 100. In one embodiment herein, the plurality of modules 108 comprises a video processing module 110, an object detection and tracking module 112, a simulation module 114, a state prediction module 116, an action recommendation module 118, and an output module 120. The processor 104 executes these modules in a sequential and pipelined manner, beginning with receiving and normalizing video frames from the user device 126, followed by detecting and tracking game entities, simulating physics-based world-model dynamics, forecasting future game states, generating frame-synchronized coaching instructions, and ending with formatting and transmitting the coaching instructions to the user interface 128 on the user device 126.

In one embodiment herein, the video processing module 110 is configured to receive the live video feed of the video game from the user device 126 and to convert sequential video frames into a normalized numerical tensor representation. The video processing module 110 is configured to perform operations including frame decoding, color space conversion, scaling, normalization, and batching of pixel data. The normalized numerical tensor representation produced by the video processing module 110 is configured to serve as an input to the object detection and tracking module 112 and to other modules of the system 100. In one embodiment herein, the live video feed is captured using one or more capture sources including hardware capture cards, software frame buffer access, emulators, screen capture utilities, digital cameras, web cameras, or streaming outputs from gaming consoles or personal computers.

In one embodiment herein, the system 100 processes one or more visual data streams comprising raw video frames, compressed video data, rendered frames, or derived visual representations. In addition, the system 100 may optionally incorporate auxiliary data including timing information, audio cues, metadata overlays, or partial state indicators when available, without reliance on internal game logic or proprietary interfaces.

In one embodiment herein, the system 100 utilizes artificial intelligence models including machine learning and deep learning models to analyze visual data, infer game state, and generate coaching instructions. The artificial intelligence models may include, but are not limited to, convolutional neural networks (CNNs), deep neural networks (DNNs), recurrent neural networks (RNNs), regression-based models, reinforcement learning models, support vector machines (SVMs), or combinations thereof.

In one embodiment herein, the neural networks comprise a plurality of layers including, but not limited to, convolutional layers, activation layers, pooling layers, dropout layers, fully connected layers, and output layers. Each layer performs mathematical operations on weighted inputs received from a preceding layer to extract visual features, classify entities, and generate structured representations of the game environment.

In one embodiment herein, the artificial intelligence models are trained using one or more learning methods including supervised learning, unsupervised learning, semi-supervised learning, reinforcement learning, or regression-based learning. Training data may include labeled gameplay footage, synthetic simulations, expert gameplay demonstrations, or combinations thereof.

In one embodiment herein, the trained artificial intelligence models are periodically updated based on newly collected gameplay data, simulated outcomes, or expert-annotated examples. Model parameters and neural network weights may be stored in the database 124 and updated through offline training or cloud-based learning pipelines to improve prediction accuracy and coaching effectiveness over time. In one embodiment herein, the system 100 adapts generated guidance based on user-specific performance patterns, historical gameplay behavior, or detected skill progression. The adaptation enables personalized coaching without modifying the underlying prediction or simulation logic.

In one embodiment herein, the object detection and tracking module 112 is configured to process the normalized numerical tensor representation using a trained convolutional neural network and related computer vision algorithms to identify, classify, and continuously track a plurality of game entities and environmental elements within the video frames, including determining pixel-based coordinate data and velocity vectors. The object detection and tracking module 112 is configured to identify interactable environmental objects, including player-controlled characters, non-player characters, projectiles, collectibles, environmental hazards, or interactable objects within the video frames by comparing detected visual patterns and textures against learned feature representations and interactive object pattern databases.

In one embodiment herein, the object detection and tracking module 112 is further configured to compute, frame-by-frame, coordinate data in pixel units for each identified entity, along with a state classification and a velocity vector. The object detection and tracking module 112 measures distances between entities in pixel units, infers motion vectors by tracking entity positions across successive frames, and calculates time-to-collision values in video frame units based on measured distances and relative velocities. The object detection and tracking module 112 is configured to output, for each tracked entity or environmental element, a structured representation including position, velocity, state, and temporal evolution suitable for world-model simulation.

In one embodiment herein, the simulation module 114 is configured to implement a physics engine that operates on coordinate data and velocity vectors output from the object detection and tracking module 112 to compute predicted motion outcomes using game-specific physical constants. The simulation module 114 applies game-specific physical constants, including gravity, friction, acceleration, and collision parameters retrieved from the database 124 or inferred from observed gameplay behavior. The predicted motion outcomes include at least one of jump trajectories, projectile paths, collision outcomes, momentum conservation, friction effects, or ramp traversal mechanics to reconstruct a forward-simulated world state that predicts how entities may move and interact over a future time horizon.

In one embodiment herein, the state prediction module 116 is configured to analyze historical tracking data, simulation outputs from the simulation module 114, and game-specific behavior models from the database 124 to forecast future game states. The state prediction module 116 predicts future state transitions of one or more detected entities by analyzing temporal visual patterns, motion vectors, animation states, or historical trajectory data derived from sequential video frames. The state prediction module 116 also predicts enemy patrol paths, attack cycles, and spawn events by applying pattern recognition algorithms to observed movement and animation sequences; generate line-of-sight probability maps and visibility heatmaps based on environmental geometry and entity positions; and assess enemy detection likelihood and safe movement paths by performing ray casting calculations in a reconstructed spatial model of the game scene.

In one embodiment herein, the state prediction module 116 is further configured to predict optimal response timing by correlating sprite animation phases, on-screen display elements such as health points and resource meters, and simulated physics outcomes with a future game timeline measured in video frames. The state prediction module 116 produces frame-accurate predictions of entity positions, incoming attacks, environmental state transitions including moving platforms, timed hazards, or dynamic obstacles, and risk levels for candidate player actions, thereby providing a world-model based predictive representation that extends beyond merely describing the current frame.

In one embodiment herein, the action recommendation module 118 is configured to generate real-time coaching instructions by applying rule-based decision logic, utility functions, and policy models to the current game state and the forecasted future game state generated by the state prediction module 116. The action recommendation module is configured to select coaching instructions from movement actions, attack actions, defensive actions, or interaction actions based on predicted risk and reward. The coaching instructions include pixel-precise spatial directives, such as “move left by a specified number of pixels” or “jump when the enemy reaches a predetermined screen coordinate,” and temporally bound commands whose execution is synchronized to specific future frames, such as “jump in 3 frames” or “fire at the next animation phase.” The action recommendation module 118 is configured to ensure that the timing of the recommended actions adheres to a predefined tolerance window, for example ±3 frames relative to predicted optimal execution frames.

In one embodiment herein, the output module 120 is configured to format the coaching instructions generated by the action recommendation module 118 into a modality-appropriate representation for delivery to the user device 126 in temporal alignment with the live video feed. The output module 120 may encode visual overlays including arrows, highlighted regions, and trajectory markers; generate synthesized audio prompts aligned to predicted event timings; or generate haptic patterns corresponding to imminent threats or required actions. The output module 120 transmits the formatted coaching instructions to the user interface 128 of the user device 126 with timing synchronized to the live video feed. The coaching instructions comprise machine-generated visual indicators, alerts, or overlays synchronized with the video feed and do not include automated control or modification of gameplay inputs.

In one embodiment herein, coaching outputs are provided via one or more modalities including visual overlays, graphical indicators, textual prompts, audio cues, haptic feedback, or combinations thereof. The modality and presentation format may be dynamically selected based on user preferences, device capabilities, accessibility requirements, or gameplay context.

In one embodiment herein, the output module 120 is engineered according to a gameplay-first design philosophy in which preservation of the live gameplay video signal is prioritized at every stage of the video pipeline, even if such prioritization results in increased latency for overlay graphics. This design approach is based on the recognition that latency during interactive gameplay is most readily perceived as small inconsistencies between a user's control input and the displayed gameplay motion. Human perceptual sensitivity to such inconsistencies is significantly higher than sensitivity to passive visual latency, which explains why interactive gaming environments often favor refresh rates of 120 frames per second or higher, whereas passive video viewing applications, such as television broadcasts, are generally perceived as acceptable at approximately 24 frames per second.

This gameplay-first design philosophy is effective because user interaction with coaching overlays does not involve direct control of gameplay elements and is therefore perceptually analogous to a viewer's interaction with non-interactive visual content. As a result, latency associated with overlay rendering is substantially less perceptible than latency in the gameplay video path. This characteristic provides tolerance for unavoidable sources of delay associated with overlay generation while maintaining real-time gameplay responsiveness.

Existing video overlay and compositing solutions exhibit critical limitations when applied to interactive gaming environments. Software-based video capture and overlay systems commonly introduce frame-level latency on the order of approximately 50 to 200 milliseconds due to buffering, decoding, and rendering pipelines, which is subjectively unacceptable for real-time gameplay. Traditional video processors lack sufficient programmability to dynamically incorporate overlay content generated from real-time inference. GPU-based compositing solutions require expensive hardware resources, increased power consumption, and introduce additional processing latency. Existing FPGA-based video solutions are typically designed for static overlays such as logos or timestamps and do not provide architectural preference for preserving the latency characteristics of one video signal over another. The disclosed system 100 addresses these limitations by implementing a hardware-assisted video compositor configured to blend dynamically generated overlay graphics with a live video signal in real time while maintaining sub-frame latency in the gameplay video path.

In one embodiment herein, the system 100 is implemented using a prototype hardware platform for development and validation purposes. The prototype implementation is realized on a system-on-chip platform comprising a Xilinx Zynq-7020 device. This platform is selected for its integration of a general-purpose processing subsystem and programmable logic fabric, as well as the availability of a mature development and verification toolchain, and is not intended to limit the system 100 to a specific production hardware configuration.

In one embodiment herein, the prototype platform comprises a dual-core ARM Cortex-A9 processor configured to execute control-plane operations, system management functions, and network communication tasks. The programmable logic portion of the platform comprises Artix-7 class programmable logic configured to implement the video datapath, including video input and output interfaces, streaming signal transport, and overlay compositing logic. The prototype platform further includes an integrated DDR3 memory controller coupled to external memory for storage of overlay frame buffers and intermediate data. Development, synthesis, and verification of the prototype implementation are performed using the Vivado Design Suite version 2025.2.

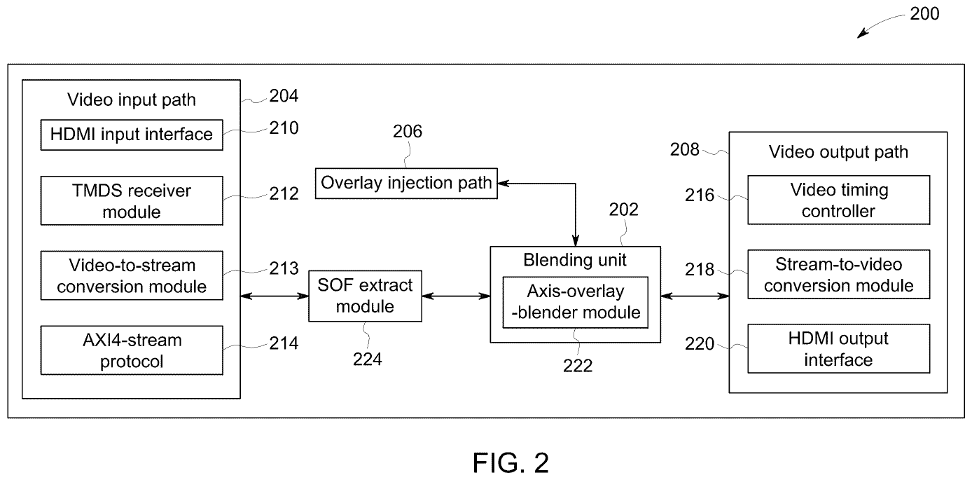

FIG. 2 refers to a block diagram of the compositor architecture 200 of the system 100. The disclosed compositor architecture 200 is intentionally designed for portability to cost-optimized production hardware. In one embodiment herein, the compositor architecture 200 is implemented on a low-cost field-programmable gate array in which the core video pipeline, including TMDS input and output interfaces, an AXI4-Stream datapath, and an alpha blending module, is realized using minimal logic resources relative to the prototype platform. This enables deployment on significantly lower-cost programmable logic devices while maintaining real-time compositing performance.

In another embodiment herein, the compositor architecture 200 is implemented as an application-specific integrated circuit. The alpha blending algorithm utilized by the compositor architecture 200 employs fixed-point arithmetic operations including 8-bit integer multiplication, addition, and bit-shifting, without reliance on floating-point computation or complex digital signal processing blocks. This architecture enables efficient ASIC implementation with reduced power consumption, reduced silicon area, and deterministic sub-frame latency performance. In one embodiment herein, the final production implementation is realized using an ASIC configured to execute the disclosed video compositing pipeline.

In one embodiment herein, the compositor architecture 200 comprises three primary datapaths that converge at a blending unit 202. The three datapaths include a video input path 204, an overlay injection path 206, and a video output path 208. Each datapath 204, 206, and 208 is configured to operate in coordination to preserve timing characteristics of the live video feed while enabling real-time compositing of dynamically generated overlay graphics.

In one embodiment herein, the video input path 204 is configured to receive a live video signal via an HDMI input interface 210 using Transition-Minimized Differential Signaling (TMDS). The input signal comprises three differential data pairs and a differential clock pair. A TMDS receiver module 212 deserializes the incoming TMDS signal and recovers an associated pixel clock. In one embodiment herein, the TMDS deserialization and pixel clock recovery are performed using a dvi2rgb intellectual property core. The input interface 210 further includes an EDID configuration stored and communicated via an I2C/DDC interface to advertise supported display modes, including 1080p CEA timing.

The recovered parallel RGB video data is converted into a streaming video format by a video-to-stream conversion module 213 configured to translate the parallel RGB signal into an AXI4-Stream protocol 214. In one embodiment herein, the AXI4-Stream video signal comprises 24-bit RGB pixel data and includes associated sideband signals, including a TUSER signal indicating a start-of-frame condition and a TLAST signal indicating an end-of-line condition. The AXI4-Stream representation enables deterministic, low-latency transport of video data through the compositing pipeline.

In one embodiment herein, the overlay injection path 206 is configured to supply dynamically generated overlay graphics to the blending unit 202. Overlay frames are stored in external memory and are read by an AXI Video Direct Memory Access (VDMA) engine operating in a memory-to-stream (MM2S) configuration, without requiring write-back of video data. In one embodiment herein, the VDMA reads overlay frames formatted as RGBA pixel data from a double-buffered frame storage region implemented in DDR3 memory. One or more overlay frame buffers are allocated at memory locations 0x10000000 and 0x10800000, each buffer having a capacity of approximately 8.3 megabytes. The double-buffered configuration enables tear-free updates by allowing one buffer to be actively displayed while the other buffer is updated with new overlay content.

The overlay injection path 206 further includes a line buffer having a capacity of approximately 16 kilobytes and supports a maximum burst length of 256 beats to optimize memory access efficiency. In one embodiment herein, memory access is provided via a high-performance memory interface port operating at approximately 200 megahertz, providing sufficient bandwidth to sustain real-time overlay delivery without stalling the video pipeline.

In one embodiment herein, the overlay injection path 206 is configured to supply dynamically generated overlay graphics to the blending unit 202. Overlay frames are stored in external memory and are read by an AXI Video Direct Memory Access (VDMA) engine operating in a memory-to-stream (MM2S) configuration, without requiring write-back of video data.

In one embodiment herein, the VDMA reads overlay frames formatted as RGBA pixel data from a double-buffered frame storage region implemented in DDR3 memory. The overlay frame buffers are allocated at memory locations 0x10000000 and 0x10800000, each buffer having a capacity of approximately 8.3 megabytes. The double-buffered configuration enables tear-free updates by allowing one buffer to be actively displayed while the other buffer is updated with new overlay content. The overlay injection path 206 further includes a line buffer having a capacity of approximately 16 kilobytes and supports a maximum burst length of 256 beats to optimize memory access efficiency. In one embodiment herein, memory access is provided via a high-performance memory interface port operating at approximately 200 megahertz, providing sufficient bandwidth to sustain real-time overlay delivery without stalling the video pipeline.

In one embodiment herein, the video output path 208 is configured to regenerate video timing signals and transmit the composited video signal to a display device. A video timing controller 216 generates output timing corresponding to a target display mode, including 1080p timing. In one embodiment herein, the video timing controller 216 operates in a slave mode in which output timing is synchronized to the incoming video signal using start-of-frame state feedback. The composited AXI4-Stream video data is converted back into a parallel RGB video format by a stream-to-video conversion module 218. The parallel RGB video signal is then encoded into a TMDS format using an rgb2dvi intellectual property core and transmitted via an HDMI output interface 220. This architecture enables preservation of the original video timing and resolution while inserting overlay graphics in real time, without introducing frame buffering or re-timing of the live video feed.

In one embodiment herein, the blending unit 202 comprises an axis-overlay-blender module 222 configured to perform per-pixel alpha compositing of overlay graphics with a live video signal. The axis-overlay-blender module 222 implements a standard Porter-Duff “over” compositing operator to combine overlay pixel values with corresponding video pixel values.

For each color channel of a pixel, including red (R), green (G), and blue (B), the output pixel value is computed according to the following relationship:

Output=(Overlay×Alpha)+(Video×(255−Alpha))

Where Overlay represents the overlay pixel channel value, Video represents the corresponding live video pixel channel value, and Alpha represents an associated transparency value for the overlay pixel.

In one embodiment herein, the alpha blending operation is implemented using fixed-point arithmetic. Multiplication results are represented using a 16-bit intermediate value, and implicit division by 256 is achieved by selecting bits [15:8] of the multiplication result. This fixed-point implementation avoids floating-point computation and enables deterministic, low-latency execution suitable for real-time video streams. This implementation provides 8-bit alpha precision, corresponding to 256 discrete transparency levels per pixel. When the alpha value is zero, the live video pixel passes through the blending unit 202 unchanged, resulting in full transparency of the overlay. When the alpha value is 255, the overlay pixel completely replaces the underlying video pixel, resulting in full opacity. Intermediate alpha values produce proportional blending between the overlay and video signals.

In one embodiment herein, the axis-overlay-blender module 222 is implemented using purely combinational logic without pipeline registers in the blend path. As a result, the blending operation introduces no additional pixel, line, or frame latency into the video datapath, thereby preserving the timing characteristics of the live video feed while enabling real-time overlay compositing.

In one embodiment herein, frame synchronization within the compositing pipeline is provided by a SOF extract module 224 configured to detect a start-of-frame condition in an AXI4-Stream video signal. In the AXI4-Stream protocol 214, the start of a new video frame is indicated by assertion of a TUSER sideband signal coincident with a valid pixel transfer. In one embodiment herein, the SOF extract module 224 monitors a logical conjunction of a transfer-valid signal and the TUSER signal on each clock cycle. The SOF extract module 224 registers the condition in which both the transfer-valid signal and the TUSER signal are asserted and detects a rising-edge transition of this condition from a deasserted state to an asserted state.

Upon detection of the rising edge of the combined (tvalid AND tuser) condition, the SOF extract module 224 generates a single-clock-cycle frame synchronization pulse, referred to herein as an fsync signal. The fsync signal corresponds to the first pixel of a new video frame and provides an explicit timing reference aligned to the video data stream. In one embodiment herein, the SOF extract module 224 is implemented such that the video data path remains purely combinational, with no pipeline registers or buffering introduced by the frame detection logic. As a result, detection of the start-of-frame condition introduces zero additional latency into the video datapath. The fsync output generated by the SOF extract module 224 is used to synchronize overlay buffer updates, buffer selection, or overlay content transitions to video frame boundaries. This enables frame-accurate overlay updates and ensures that changes to overlay graphics occur atomically at the start of a video frame, thereby preventing visual tearing or temporal misalignment between the live video feed and the overlay content.

In one embodiment herein, a prototype implementation of the disclosed system 100 is constructed and validated to demonstrate the functionality and performance of the core video compositing architecture. The system 100 is configured to operate using industry-standard video interfaces and timing parameters to verify correct operation of the video input path 204, overlay injection path 206, blending unit 202, and video output path 208 under real-time conditions. The prototype implementation has been validated using the specifications summarized in Table 1. These specifications represent tested operating parameters of the prototype system 100 and are provided to illustrate one non-limiting example of a working embodiment. The disclosed architecture is not restricted to these parameters and may be scaled to support additional resolutions, frame rates, and color formats in production implementations.

TABLE 1

| Parameter | Prototype Specification |
|---|---|
| Interface | HDMI 1.4/DVI 1.0 (TMDS signaling) |
| Validated Resolution | 1920 × 1080 (Full HD) |
| Validated Frame Rates | 30 Hz and 60 Hz (progressive scan) |
| Color Depth | 24-bit RGB (8 bits per channel) |
| Color Space | RGB 4:4:4 |
| Pixel Clock (1080p60) | 148.5 MHz |
| EDID Configuration | 1080 p CEA timing (dgl_1080p_cea.data) |

In one embodiment herein, the prototype system 100 operates at a pixel clock frequency of approximately 148.5 megahertz for 1080p video at 60 frames per second. The use of standard CEA timing parameters and a corresponding EDID configuration ensures compatibility with common display devices and facilitates reliable validation of timing preservation, synchronization, and overlay compositing behavior.

In one embodiment herein, the production implementation of the disclosed system 100 targets compliance with the HDMI 2.1 specification to support higher resolutions, higher frame rates, and advanced video features. The disclosed compositing architecture imposes no fundamental limitations on supported resolution or frame rate, as video scaling capability is primarily determined by the physical interface bandwidth and available memory bandwidth for overlay buffering rather than by the compositing logic itself.

In one embodiment herein, scaling of the system 100 to higher resolutions and refresh rates is achieved by selecting an appropriate physical layer (PHY) implementation and provisioning sufficient memory bandwidth to support overlay frame storage and transfer. The core compositing pipeline, including streaming datapaths and alpha blending logic, operates independently of resolution and frame rate and is therefore adaptable to a wide range of video formats.

In one embodiment herein, the target production specifications for one embodiment of the system are summarized in Table 2. These specifications represent non-limiting examples of supported operating parameters for production deployments.

TABLE 2

| Parameter | Target Specification |
|---|---|
| Interface | HDMI 2.1 (full specification) |
| Maximum Resolution | 3840 × 2160 @ 60 Hz/120 Hz (4 K UHD) |
| | 7680 × 4320 @ 30 Hz/60 Hz (8 K UHD) |
| | 1920 × 1080 @ 240 Hz (Full HD, high refresh) |
| Maximum Throughput | 48 Gbps (Fixed Rate Link encoding) |
| Color Depth Support | 24-bit (8 bpc), 30-bit (10 bpc), |
| | 36-bit (12 bpc), 48-bit (16 bpc) |
| HDR Support | Static HDR (HDR10), Dynamic HDR |
| | (HDR10+, Dolby Vision) |
| Variable Refresh Rate | VRR, ALLM (Auto Low Latency Mode) |
| Compression | Display Stream Compression (DSC) |
| | 1.2 for highest modes |
| Audio | eARC (enhanced Audio Return Channel), |
| | Dolby Atmos, DTS:X |

In one embodiment herein, support for advanced HDMI 2.1 features including variable refresh rate, low-latency modes, and high dynamic range enables the system 100 to operate in demanding interactive environments such as high-refresh-rate gaming, competitive esports, and advanced visualization systems while preserving real-time overlay compositing behavior.

In one embodiment herein, the output module 120 is configured to generate a composited video signal that preserves the timing characteristics of the incoming live video feed while superimposing dynamically generated overlay graphics. The output signal is produced using a pass-through architecture in which the output timing matches the input timing, thereby avoiding re-timing, frame buffering, or frame rate conversion of the live gameplay video. In one embodiment herein, the output signal comprises two composited layers, including a live video layer and an overlay graphics layer. The overlay graphics layer is formatted as a 32-bit RGBA signal comprising red, green, blue, and alpha components, with the alpha component providing per-pixel transparency control for blending the overlay with the live video.

In one embodiment herein, alpha precision is provided at 8 bits per pixel, corresponding to 256 discrete transparency levels. The alpha blending architecture is scalable to support higher precision, including 10-bit or 12-bit alpha channels, without modification to the fundamental compositing pipeline. In one embodiment herein, clean output timing is generated using the video timing controller 216 configured to regenerate timing signals corresponding to the input video format. The video timing controller 216 ensures stable synchronization of the composited output signal while maintaining alignment with the input video stream. This configuration enables real-time overlay compositing without introducing perceptible latency or visual artifacts. The output signal specifications validated for one embodiment of the system 100 are summarized in Table 3.

TABLE 3

| Parameter | Specification |
|---|---|
| Output Timing | Matches input (pass-through architecture) |
| Composited Layers | 2 (live video + RGBA overlay) |
| Overlay Format | 32-bit RGBA (8-bit alpha channel) |
| Alpha Precision | 8-bit (256 levels), scalable to 10-bit or 12-bit |
| Timing Regeneration | Clean timing via Video Timing Controller |

In one embodiment herein, the prototype implementation of the disclosed system 100 utilizes standardized internal bus protocols to transport video data, overlay data, and memory transactions between functional blocks. The internal bus architecture is selected to provide deterministic timing, high throughput, and portability across different hardware platforms. In one embodiment herein, video data within the compositing pipeline is transported using the AXI4-Stream protocol 214. The AXI4-Stream protocol 214 provides a unidirectional, low-latency streaming interface suitable for real-time video processing and supports sideband signaling for frame and line synchronization. Although AXI4-Stream is used in the prototype implementation, the disclosed architecture is not limited to this protocol and may be adapted to other streaming interfaces or custom interconnects as required by a target platform.

In one embodiment herein, the video stream data width comprises 24 bits per pixel corresponding to RGB color data. The internal bus architecture is scalable to support increased video data widths, including 30-bit or 36-bit formats, to accommodate higher color depth configurations in production embodiments. In one embodiment herein, overlay data is transported using a streaming interface with a data width of 32 bits per pixel corresponding to RGBA color data. The overlay data path is similarly scalable to support wider data widths, including 40-bit or 48-bit formats, to enable higher precision color and alpha channels.

In one embodiment herein, the memory interface utilized in the prototype implementation conforms to an AXI4 protocol. The memory interface is configured to support direct memory access (DMA) operations for efficient transfer of overlay frame data between external memory and the compositing pipeline. The disclosed architecture is not limited to a specific memory interface standard and may employ any generic DMA-capable memory interface suitable for the target hardware platform. The internal bus specifications validated for the prototype implementation are summarized in Table 4.

TABLE 4

| Parameter | Specification |
|---|---|
| Video Stream Protocol | AXI4-Stream (portable to other |
| | IP or custom interfaces) |
| Video TDATA Width | 24 bits (RGB), scalable to 30-bit or 36-bit |
| Overlay TDATA Width | 32 bits (RGBA), scalable to 40-bit or 48-bit |
| Memory Interface | AXI4 (prototype); generic DMA capable |

In one embodiment herein, the disclosed system 100 provides a significant reduction in end-to-end video latency relative to conventional software-based overlay and compositing solutions. The reduced latency is achieved by a hardware-assisted, pass-through video architecture in which the live video feed is not frame-buffered, copied, or stored in external memory prior to output. A comparative latency analysis between the disclosed system 100 and typical software-based overlay systems is summarized in Table 5. As shown, the disclosed architecture introduces negligible latency at each stage of the video pipeline, resulting in a total added latency that is orders of magnitude lower than that of conventional approaches.

TABLE 5

| Component | Disclosed System | Typical Software |
|---|---|---|
| Video Capture | 0 (pass-through) | 1-3 frames |
| Compositing | <1 pixel clock | 1-2 frames |
| Output Encoding | <1 scanline | 1-2 frames |
| Total Video Path | <100 microseconds | 50-300 milliseconds |

In one embodiment herein, the primary source of the latency reduction is a zero-copy, combinational blending architecture implemented within the axis-overlay-blender module 222. The axis-overlay-blender module 222 contains no pipeline registers in the video data path. Instead, video pixels flow directly from the input interface 210 to the output interface 220 with only combinational logic delay attributable to gate propagation. This zero-copy behavior is achieved through pure wire assignments for AXI4-Stream passthrough signals, including tdata, tvalid, tlast, tuser, and tready, such that the streaming video protocol signals are forwarded without buffering or retiming. Alpha blending operations are performed using purely combinational multiplication and addition logic, and no frame buffering of the input video stream is performed at any stage of the compositing pipeline.

As a result, the disclosed system 100 preserves the timing characteristics of the incoming video feed while enabling real-time overlay compositing. The cumulative latency introduced by the video input, compositing, and output stages remains below approximately 100 microseconds, which is substantially below perceptual thresholds for interactive gameplay and does not degrade user input responsiveness.

In one embodiment herein, the disclosed system 100 minimizes external memory bandwidth requirements through a set of architectural techniques that decouple the live video datapath from memory access while allowing efficient delivery of overlay graphics. These techniques enable real-time overlay compositing without stalling the video pipeline or introducing additional latency. In one embodiment herein, the system 100 employs an overlay-only memory access strategy in which only the overlay graphics layer is read from external memory. The live video stream is processed entirely in a pass-through manner and does not traverse external memory, thereby eliminating memory bandwidth consumption associated with the primary video signal.

In one embodiment herein, the memory subsystem utilizes a single-port access architecture in which an AXI Video Direct Memory Access (VDMA) engine operates exclusively in a memory-to-stream (MM2S) configuration. No write-back of video data to memory is performed, thereby eliminating memory write bandwidth and reducing overall memory traffic.

In one embodiment herein, memory access efficiency is further improved through the use of burst-based transfers with a maximum burst length of 256 beats. This configuration maximizes dynamic random-access memory (DRAM) page locality and reduces access overhead. Additionally, a line buffer having a capacity of approximately 16 kilobytes is employed to absorb memory access latency and prevent stalls in the video processing pipeline.

By way of example, the memory bandwidth required to support an RGBA overlay at a resolution of 1920×1080 pixels and a frame rate of 60 frames per second can be calculated as:

1920×1080×4 bytes×60 Hz=approximately 497.7 megabytes per second

In one embodiment herein, this bandwidth requirement is well within the capacity of a high-performance memory interface port operating at approximately 200 megahertz, which provides a sustained bandwidth of approximately 1.6 gigabytes per second. Accordingly, the disclosed architecture supports real-time overlay delivery with substantial bandwidth margin, enabling scalability to higher resolutions or additional overlay complexity.

In one embodiment herein, the disclosed system 100 implements a set of compositing innovations within a programmable logic device that distinguish the architecture from conventional FPGA-based video overlay solutions. These innovations enable real-time, frame-accurate overlay compositing while preserving the timing characteristics of a live video stream. In one embodiment herein, the overlay framebuffer is configured to support dynamic overlay content that may be updated on a per-frame basis. Unlike static overlay inserters that are limited to fixed graphics such as logos or timestamps, the disclosed system 100 allows the overlay framebuffer to be updated every video frame with dynamically generated graphics, including graphics derived from artificial intelligence inference or real-time analysis of gameplay content.

In one embodiment herein, the compositing pipeline supports per-pixel alpha transparency using a full 8-bit alpha channel. This enables smooth anti-aliased text, translucent graphical effects, and gradual blending transitions between overlay graphics and the live video feed, thereby improving visual clarity and usability without compromising real-time performance. In one embodiment herein, the blending unit 202 operates in lockstep with the live video stream such that overlay pixels are consumed only when corresponding video pixels are actively transferred through the pipeline. This lockstep stream synchronization maintains precise spatial and temporal alignment between the overlay and video signals without requiring explicit frame counters, timers, or external synchronization logic.

In one embodiment herein, overlay updates are performed using a double-buffered memory architecture in conjunction with a VDMA engine operating in a parking mode. This configuration allows the processor 104 to write new overlay data into one buffer while the programmable logic reads overlay data from a second buffer, thereby enabling tear-free overlay updates without interrupting the video pipeline. In one embodiment herein, buffer switching is performed in a frame-synchronous manner. A complete frame of overlay data is flushed and the active buffer is toggled atomically upon receipt of a full video frame. This frame-synchronous buffer swap ensures that overlay updates occur only at frame boundaries, preventing partial-frame artifacts and maintaining visual consistency between successive frames.

In one embodiment herein, the system 100 employs explicit clock domain isolation to ensure reliable operation across multiple asynchronous clock domains. Separate reset controllers are used to independently manage the system clock domains and the video clock domain. In one embodiment, a first reset controller manages system clocks operating at approximately 100 megahertz and 200 megahertz, while a second reset controller manages a variable pixel clock associated with the incoming video signal. This separation prevents unintended interactions between control-plane logic and timing-sensitive video processing logic.

In one embodiment herein, asynchronous clock domain crossing is supported by configuring video interface modules to operate with independent clock domains. Both the video-to-stream conversion module 213 and the stream-to-video conversion module 218 are configured with asynchronous clock support enabled to ensure safe transfer of video data across clock boundaries. This configuration provides robust handling of clock domain crossing conditions without introducing metastability or data corruption.

In one embodiment herein, pixel clock recovery is performed by the TMDS receiver module 212 that extracts the pixel clock from the incoming video signal. The receiver module 212 provides a pixel clock lock indicator that is used to gate release of the video pipeline reset. This ensures that video processing logic is activated only after stable pixel clock recovery, thereby preventing undefined behavior during initialization or hot-plug events.

In one embodiment herein, the video input and output interfaces 210 and 220 utilize Transition-Minimized Differential Signaling (TMDS) to provide robust, high-speed data transfer with reduced susceptibility to common-mode noise. Differential signaling enables reliable operation at high data rates required for modern video standards. In one embodiment herein, a stable reference clock operating at approximately 200 megahertz is provided to the TMDS deserialization logic to support accurate timing recovery and data alignment. The reference clock serves as a timing anchor for high-speed signal processing operations.

In one embodiment herein, hot-plug detection is supported through a dedicated signal that is directly controlled by the system reset state. This configuration ensures proper detection and handling of cable insertion and removal events. Additionally, the system 100 employs an active-low reset architecture in which all intellectual property cores are initialized using active-low reset signals, thereby enabling reliable power-on initialization and deterministic reset behavior.

In one embodiment herein, the memory subsystem employs a double-buffered overlay frame storage architecture. Two independent overlay frame buffers are maintained such that one buffer is actively read by the compositing pipeline while a second buffer is available for writing updated overlay content. This configuration enables tear-free overlay updates and continuous video output. In one embodiment herein, buffer selection and switching are managed using a video direct memory access engine operating in a parking mode. Hardware-level buffer selection ensures atomic switching between overlay frames at appropriate synchronization points, thereby preventing partial-frame artifacts.

In one embodiment herein, cache coherency is maintained through explicit cache management operations. A data cache flush operation is performed once per complete overlay frame update to ensure memory consistency while minimizing cache maintenance overhead. This approach balances performance efficiency with data integrity in systems employing processor-based overlay generation.

In one embodiment herein, a production implementation of the system 100 employs a direct overlay delivery architecture in which an artificial intelligence processor receives video data directly from the programmable logic device and writes overlay frames directly to external memory. In one embodiment, the programmable logic device provides a downscaled copy of the incoming video signal to the artificial intelligence processor, thereby eliminating the need for external video capture hardware. In one embodiment herein, overlay frames formatted as RGBA pixel data are written by the artificial intelligence processor directly to external memory using direct memory access operations. This bypasses any network stack or intermediate transport layer and reduces end-to-end overlay delivery latency.

In one embodiment herein, overlay updates are synchronized to video frame boundaries using a frame synchronization signal generated by the SOF extract module 224. The frame synchronization signal may be used to trigger overlay buffer swaps aligned with the start of a video frame, thereby ensuring temporal consistency between the overlay graphics and the live video feed. The current prototype implementation utilizes a temporary network-based overlay delivery path due to development board limitations. This network-based path is not representative of the production architecture and is provided solely for development and validation purposes.

In one embodiment herein, the end-to-end latency of the compositor architecture 200 is analyzed by decomposing the pipeline into individual functional stages and estimating the latency contribution of each stage. The analysis considers only deterministic hardware delays introduced by signal processing and buffering within the video datapath and excludes latency associated with overlay generation or external processing. The latency components of the compositor architecture 200 for one embodiment are summarized in Table 6.

TABLE 6

| Stage | Latency | Notes |
|---|---|---|
| TMDS Deserialization (dvi2rgb) | ~10 pixel clocks | SERDES alignment |
| Video to AXI4-Stream (v_vid_in) | ~32 pixels | FIFO depth |
| Start-of-Frame Extract | 0 pixels | Combinational |
| Alpha Blender | 0 pixels | Combinational |
| AXI4-Stream to Video (v_vid_out) | ~32 pixels | FIFO depth |
| TMDS Serialization (rgb2dvi) | ~10 pixel clocks | SERDES pipeline |
| Total | ~84 pixels | |

In one embodiment herein, the start-of-frame extraction logic and the alpha blending logic are implemented using purely combinational circuitry and therefore introduce no additional pixel, line, or frame latency. The remaining latency contributions arise primarily from required serializer/deserializer alignment and first-in-first-out buffering within streaming interface conversions.

By way of example, at a resolution of 1920×1080 pixels and a frame rate of 60 frames per second, the pixel clock frequency is approximately 148.5 megahertz. At this pixel clock rate, a latency of approximately 84 pixels corresponds to a time delay of approximately 0.57 microseconds. This latency is substantially less than the duration of a single scanline, which for 1080p video comprises 1920 pixels corresponding to approximately 12.9 microseconds, and is orders of magnitude less than the duration of a single video frame, which at 60 frames per second is approximately 16.67 milliseconds. Accordingly, the disclosed compositor architecture 200 introduces latency that is well below perceptual thresholds and does not materially affect gameplay responsiveness.

In one embodiment herein, the production implementation of the disclosed system 100 eliminates the need for external video capture hardware by receiving the live video signal directly into a programmable logic device and providing a downscaled copy of the video to an artificial intelligence processor for analysis and overlay generation. This architecture minimizes end-to-end latency by removing intermediate capture, encoding, and transport stages.

The latency contributions of major components in the system 100 are summarized in Table 7.

TABLE 7

| Component | Latency | Notes |
|---|---|---|
| Video Input (HDMI | <1 microsecond | Direct TMDS |
| to FPGA) | | receive |
| Downscale and Forward | ~1 scanline | Hardware scaler |
| to AI Processor | | |
| AI Inference | 10-30 milliseconds | Model dependent |
| Overlay DMA to | <1 millisecond | Direct memory write |
| Frame Buffer | | |
| FPGA Compositor | <1 microsecond | ~84 pixels |
| Total (Production) | ~10-30 milliseconds | |

In one embodiment herein, the overall latency of the system 100 is dominated by the time required to perform artificial intelligence inference on the downscaled video feed. The video processing path itself, including video input, compositing, and output, introduces less than approximately 100 microseconds of latency from input to display.

As a result, overlay graphics generated by the system 100 may appear approximately one to two video frames behind the live gameplay action at a frame rate of 60 frames per second. However, because the live gameplay video is passed through the system 100 with effectively zero perceptible latency, user input responsiveness is preserved. The temporal offset of the overlay graphics does not materially impact gameplay, as overlay content is observational rather than control-based. Accordingly, the disclosed production architecture enables real-time gameplay with frame-synchronized coaching overlays while maintaining a gameplay video path that is perceptually indistinguishable from a direct video connection.

In one embodiment herein, the performance of the disclosed system 100 is compared with representative alternative video overlay and compositing approaches commonly used in gaming and video processing environments. The comparison focuses on video latency, compositor latency, and total end-to-end latency, as these factors directly affect gameplay responsiveness and user experience. A comparative summary of latency characteristics is provided in Table 8.

TABLE 8

| | | Compositor | |
|---|---|---|---|
| Approach | Video Latency | Latency | Total Latency |
| Disclosed FPGA-Based | <1 | <1 microsecond | <1 microsecond |
| System | microsecond | | |
| OBS Studio (CPU-Based) | 2-4 frames | 1-2 frames | 50-100 |
| | | | milliseconds |
| GPU Passthrough | 1-2 frames | ~1 frame | 33-66 |
| | | | milliseconds |
| Hardware Scaler | 1-2 frames | Not applicable | 16-33 |
| | | (static) | milliseconds |

In one embodiment herein, the disclosed system 100 achieves sub-microsecond latency by employing a pass-through video architecture in which the live video signal is never frame-buffered or copied into system memory. Compositing is performed using combinational logic synchronized directly to the video stream, resulting in negligible additional delay.

By contrast, software-based solutions such as CPU-driven video capture and overlay pipelines rely on frame buffering, decoding, and rendering stages that introduce multiple frames of latency. GPU-based passthrough solutions similarly incur frame-level latency due to buffering and graphics processing pipelines. Hardware scalers, while lower latency than software approaches, are typically limited to static processing and do not support dynamically generated overlay content. Accordingly, the disclosed FPGA-based architecture uniquely enables real-time, dynamically generated overlay compositing while maintaining a video latency that is effectively indistinguishable from a direct video connection. This capability is particularly advantageous for interactive gaming and other latency-sensitive applications.

In one embodiment herein, the disclosed system 100 has been validated through a series of functional and observational tests to confirm correct operation of the video compositing pipeline and overlay delivery architecture. The validation activities performed demonstrate functional correctness, timing integrity, and visual stability of the system 100 under real-time operating conditions. Functional verification testing confirms that the system 100 successfully composites dynamically generated overlay graphics over a live gameplay video stream. In one validation scenario, artificial intelligence-generated bounding boxes are composited over live Super Mario Bros. gameplay at a resolution of 1920×1080 pixels. The overlays are rendered in correct spatial alignment with gameplay elements and remain stable across successive video frames.

Visual latency assessment is performed through subjective testing in which live gameplay video is observed while interacting with the game in real time. This testing confirms that the video pass-through path introduces no perceptible delay between user input and displayed gameplay motion. The absence of observable lag is consistent with the sub-frame latency characteristics of the disclosed compositing architecture. Signal-level verification is performed using an integrated logic analyzer to monitor AXI4-Stream transactions within the video datapath. The captured traces confirm that streaming transactions complete within expected timing parameters and that protocol handshaking signals operate correctly. This verification is sufficient to confirm correct operation of the streaming interfaces and compositing pipeline.

Integrity of the double-buffered overlay architecture is validated by monitoring frame counters associated with buffer switching events. The observed frame counter behavior confirms that overlay buffer swaps occur without dropped frames or visual tearing, thereby validating frame-synchronous buffer switching and tear-free overlay updates. Formal latency measurements using calibrated laboratory instrumentation have not been performed due to the absence of test equipment capable of resolving delays on the order of microseconds. However, the combination of functional verification, signal-level analysis, and subjective visual testing provides sufficient evidence that the disclosed system 100 operates in accordance with its intended low-latency design.

In one embodiment herein, the system 100 is implemented as a client-server configuration in which the computing device 102 is a centralized analysis engine hosting the plurality of modules 108 via the server 125. The user device 126 executes a multi-platform application that captures the live video feed and renders the coaching instructions. In this embodiment, the multi-platform application is configured to stream the live video feed to the server 125 via the network 122, and the server 125 is configured to process the video feed using the world-model based pipeline and to return real-time coaching instructions to the multi-platform application for display on the user interface 128.

In another embodiment herein, the system 100 is implemented as a multi-platform application executable locally on the user device 126. In this embodiment, the computing device 102 is integrated into the user device 126, and the plurality of modules 108 execute on the local processor of the user device 126 without requiring a remote server. The memory 106, in this case, is provided by a local non-transitory computer-readable storage medium of the user device 126. The system 100 is configured to perform video processing, object detection and tracking, physics simulation, state prediction, and action recommendation entirely on-device. In one embodiment herein, the system 100 concurrently processes multiple video streams corresponding to different players, viewpoints, or matches. The system 100 may generate individualized coaching outputs per user or aggregated insights derived from multiple simultaneous gameplay sessions.

In one embodiment herein, the system 100 constructs and maintains an internal predictive simulation of a video game world based on pixel-level observations and physics-based modeling, in contrast to large language model (LLM)-based copilots that operate by predicting natural language tokens without explicit reconstruction of game geometry, physics, or frame-accurate entity states. The system 100 is configured to measure distances in pixels and timing in frames, reconstruct dungeon rooms and level layouts, infer interactable objects, and analyze visibility and probability maps, thereby enabling precise, context-specific coaching such as “Jump now-3 frames early” or “Push the left block” in real time. Predictive simulation comprises executing computational projections of future game states based on the current world model, detected entity dynamics, and game-specific constraints to estimate probable outcomes within a defined prediction horizon.

In one embodiment herein, predictive simulation is performed over variable temporal horizons, including short-term predictions spanning multiple video frames and longer-term projections spanning extended gameplay sequences. The prediction horizon may be dynamically adjusted based on detected game complexity, entity motion patterns, or computational constraints.

In one embodiment herein, the system 100 is configured to support a plurality of video game genres including platformers, action-adventure games, first-person shooters, role-playing games, and racing titles. For example, in a platform game, the system 100 can compute jump arcs, enemy movement, and safe landing zones; in a stealth or shooter game, the system 100 can build 3D probability and visibility maps to anticipate guard patrols and line-of-sight events; and in a role-playing game, the system 100 can read on-screen combat status indicators in real time and recommend healing or defensive actions in anticipation of incoming attacks.

In one embodiment herein, the processor 104 of the computing device 102 is further configured to log, in the memory 106 or in an associated storage, historical game state data, predicted states, and coaching instructions, thereby enabling offline analysis of system performance and training of improved world-model and policy components. The logged data can be utilized to refine physical constants, update enemy behavior templates in the database 124, and optimize decision rules used by the action recommendation module 118, thereby continuously improving the accuracy and responsiveness of the system 100 for real-time video game analysis and coaching.

In one embodiment herein, the system 100 is configured for commercial deployment as a licensed software platform, software development kit (SDK), or service offering provided to third parties. The system 100 may be licensed to video game publishers, streaming platforms, esports organizations, hardware manufacturers, or accessibility service providers for integration into gameplay experiences, broadcast environments, training tools, or assistive applications. In one embodiment herein, the system 100 operates independently of game engine integration and does not require access to internal game logic or application programming interfaces. This enables the system 100 to be licensed for use with legacy games, closed-source titles, and third-party platforms without modification to the underlying game software.

In one embodiment herein, the system 100 is deployed as a subscription-based service, usage-based service, or enterprise license. Coaching instructions, predictive analytics, and performance insights may be delivered in real time or recorded for later review, enabling monetization across consumer, professional, and competitive gaming environments. In one embodiment herein, the system 100 is configured to generate predictive overlays and coaching indicators for live or recorded broadcasts of competitive gameplay. The generated overlays may illustrate anticipated player actions, predicted enemy movement, or optimal decision timing for viewers, commentators, or analysts without influencing player input. In one embodiment herein, the system 100 provides assistive guidance for users with cognitive, motor, or perceptual impairments by delivering simplified, anticipatory cues synchronized with gameplay events. The system 100 improves accessibility by reducing reaction-time burden and enhancing situational awareness without automating gameplay actions.

FIG. 2 refers to a flow chart 200 of a method for real-time video game analysis and coaching using the system 100. At step 202, the video processing module 110 of the computing device 102 receives a live video feed of a video game from the user device 126. The live video feed can be obtained from a hardware capture card, a game emulator output, a game console, or a direct frame buffer access module of the user device 126.

At step 204, the object detection and tracking module 112 processes pixel data from the received video feed to identify, classify, and continuously track a plurality of game entities, interactive objects, and environmental elements. The object detection and tracking module 112 further determines coordinate data in pixel units and computes velocity vectors for each tracked element. In one embodiment herein, the object detection and tracking module 112 measures distances between identified game entities in pixel units, identifies interactable environmental objects including moveable blocks, torches, doors, and switches by comparing detected textures against a database of interactive object patterns, and detects and tracks on-screen display elements including health point values, resource levels, and active status effects.

At step 206, the simulation module 114 simulates in-game physics to compute trajectories, collisions, jump arcs, and motion outcomes using game-specific physical constants derived from gameplay characteristics or retrieved from the game profile database 124. In one embodiment herein, the simulation module 114 further simulates complex environmental interactions, including ramp-traversal mechanics, loop physics, and velocity conservation to generate forward-projected game state estimates.

At step 208, the state prediction module 116 forecasts future game states by analyzing historical tracking data obtained from the object detection and tracking module 112, and simulation outputs generated by the simulation module 114. The state prediction module 116 produces frame-accurate predictions of entity positions, enemy behaviors, environmental transitions, and probable attack timings. In one embodiment herein, the state prediction module 116 predicts enemy patrol patterns and attack cycles using pattern-recognition algorithms, generates line-of-sight probability maps and visibility heatmaps based on game entities and environmental geometry, assesses enemy detection likelihood and safe movement paths using ray-casting calculations, and predicts optimal response timing by analyzing sprite animation phases and on-screen display elements.

At step 210, the action recommendation module 118 generates real-time, frame-synchronized coaching instructions by applying rule-based decision logic to the current game state and the forecasted future game states generated by the state prediction module 116. The coaching instructions include pixel-precise spatial directives and temporally-bound action commands intended for execution at specific future video frames. In one embodiment herein, the action recommendation module 118 generates action commands with a timing tolerance of +3 video frames relative to predicted optimal execution frames.

At step 212, the output communication module 120 delivers the coaching instructions to the user interface 128 on the user device 126 with timing synchronized to the live video feed. The output communication module 120 formats the coaching instructions according to the delivery medium and ensures temporal alignment with the corresponding gameplay frames. In one embodiment herein, delivering the coaching instructions includes delivering via a modality selected from an on-screen visual overlay, synthesized audio speech, or haptic feedback, depending on capabilities of the user device 126.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for real-time video game analysis and coaching, comprising:
a computing device having at least one processor and a memory storing instructions that, when executed by the processor, cause the processor to implement a plurality of modules,
wherein the computing device is in communication with a server and a database via a network;
wherein the plurality of modules comprises:
a video processing module configured to receive a live video feed of a video game from a user device and to convert sequential video frames into a normalized numerical tensor representation;
an object detection and tracking module configured to process the normalized numerical tensor representation using at least one trained convolutional neural network and related computer-vision algorithms to identify, classify, and continuously track a plurality of game entities and environmental elements within the video frames, including determining pixel-based coordinate data and velocity vectors;
a simulation module configured to implement a physics engine that operates on the pixel-based coordinate data and velocity vectors output from the object detection and tracking module to compute predicted motion outcomes using game-specific physical constants;
a state prediction module configured to analyze historical tracking data, simulation outputs generated by the simulation module, and game-specific behavior models retrieved from the database to forecast future game states;
an action recommendation module configured to generate real-time coaching instructions by applying rule-based decision logic, utility functions, and policy models to a current game state and at least one forecasted future game state generated by the state prediction module; and
an output module configured to format the coaching instructions generated by the action recommendation module into a modality-appropriate representation and to deliver the formatted coaching instructions to the user device in temporal alignment with the live video feed.

2. The system for real-time video game analysis and coaching of claim 1, wherein the object detection and tracking module is configured to detect at least one of player-controlled characters, non-player characters, projectiles, collectibles, environmental hazards, or interactable objects within the video frames.

3. The system for real-time video game analysis and coaching of claim 1, wherein the object detection and tracking module is configured to measure distances between entities in pixel units, infers motion vectors by tracking entity positions across successive frames, and calculates time-to-collision values in video frame units based on measured distances and relative velocities.

4. The system for real-time video game analysis and coaching of claim 1, wherein the object detection and tracking module is further configured to identify interactable environmental objects by comparing detected textures against a database of interactive object patterns.

5. The system for real-time video game analysis and coaching of claim 1, wherein the predicted motion outcomes include at least one of jump trajectories, projectile paths, collision outcomes, momentum conservation, friction effects, or ramp traversal mechanics.

6. The system for real-time video game analysis and coaching of claim 1, wherein the game-specific physical constants are retrieved from the database or inferred from observed gameplay behavior.

7. The system for real-time video game analysis and coaching of claim 1, wherein the state prediction module is configured to predict future state transitions of one or more detected entities by analyzing temporal visual patterns, motion vectors, animation states, or historical trajectory data derived from sequential video frames.

8. The system for real-time video game analysis and coaching of claim 1, wherein the state prediction module is configured to generate at least one of a line-of-sight probability map or a visibility heatmap based on reconstructed spatial geometry of the game environment.

9. The system for real-time video game analysis and coaching of claim 1, wherein the state prediction module is configured to forecast environmental state changes including moving platforms, timed hazards, or dynamic obstacles.

10. The system for real-time video game analysis and coaching of claim 1, wherein the coaching instructions include pixel-precise spatial directives and temporally-bound action commands mapped to specific future video frames.

11. The system for real-time video game analysis and coaching of claim 10, wherein the action commands are generated with an execution timing tolerance of ±3 video frames relative to a predicted optimal execution frame.

12. The system for real-time video game analysis and coaching of claim 1, wherein the action recommendation module is configured to select coaching instructions from movement actions, attack actions, defensive actions, or interaction actions based on predicted risk and reward.

13. The system for real-time video game analysis and coaching of claim 1, wherein the output module is configured to render visual overlays on the live video feed that depict at least one of recommended movement paths, predicted entity positions, or action timing indicators.

14. The system for real-time video game analysis and coaching of claim 1, wherein the output module is configured to deliver the coaching instructions as synthesized audio prompts or haptic feedback synchronized to predicted gameplay events.

15. The system for real-time video game analysis and coaching claim 1, wherein the computing device is implemented as a server-side analysis engine and the user device is configured to stream the live video feed to the computing device via the network.

16. A method for real-time video game analysis and coaching using a system, comprising:
receiving, by a video processing module executed by a computing device, a live video feed of a video game from a user device and converting sequential video frames of the live video feed into a normalized numerical tensor representation;
processing, by an object detection and tracking module executed by the computing device, the normalized numerical tensor representation using at least one trained convolutional neural network and related computer-vision algorithms to identify, classify, and continuously track a plurality of game entities and environmental elements within the video frames, including determining pixel-based coordinate data and velocity vectors;
simulating, by a simulation module executed by the computing device, in-game physics by operating a physics engine on the pixel-based coordinate data and velocity vectors to compute predicted motion outcomes using game-specific physical constants;
forecasting, by a state prediction module executed by the computing device, future game states by analyzing historical tracking data, simulation outputs generated by the simulation module, and game-specific behavior models retrieved from a database;
generating, by an action recommendation module executed by the computing device, real-time coaching instructions by applying rule-based decision logic, utility functions, and policy models to a current game state and at least one forecasted future game state generated by the state prediction module; and
delivering, by an output module executed by the computing device, the coaching instructions to the user device in temporal alignment with the live video feed.

17. The method of claim 16, wherein the object detection and tracking module is configured to measure distances between entities in pixel units, infers motion vectors by tracking entity positions across successive frames, and calculates time-to-collision values in video frame units based on measured distances and relative velocities.

18. The method of claim 16, wherein the predicted motion outcomes include at least one of jump trajectories, projectile paths, collision outcomes, momentum conservation, friction effects, or ramp traversal mechanics.

19. The method of claim 16, wherein the game-specific physical constants are retrieved from the database or inferred from observed gameplay behavior.

20. The method of claim 16, wherein the coaching instructions include pixel-precise spatial directives and temporally-bound action commands mapped to specific future video frames, and wherein the action commands are generated with an execution timing tolerance of +3 video frames relative to a predicted optimal execution frame.
